(19) United States
(12) Patent Application Publication
(10) Pub. No.: US 2005/0144025 A1
(43) Pub. Date: Jun. 30, 2005

(54) Using technical performance metrics for business and usage analysis and cost allocation

(75) Inventors: Hagai Katz, Yavne (IL); Eyal M. Yechieli, Tel-Aviv (IL)

Correspondence Address: MEYERTONS, HOOD, KIVLIN, KOWERT & GOETZEL, P.C., P.O. BOX 398, AUSTIN, TX, 78767-0398, US

(73) Assignee: VERITAS Operating Corporation

(21) Appl. No.: 10/747,841

(22) Filed: Dec. 29, 2003

(51) Int. Cl. G06F 17/60

(52) U.S. Cl. 705/1; 705/400

(57) ABSTRACT

A method and system are provided for allocating resource usage costs in a computer system comprising a plurality of system resources. A cost is determined for each of the system resources. A cost allocation method is determined for each of the system resources. Resource usage by a particular organizational unit is determined for each of the system resources. The cost of resource usage by the organizational unit is programmatically determined based on the cost for each of the system resources, the cost allocation method for each of the system resources, and the resource usage by the organizational unit for each of the system resources.

### BACKGROUND OF THE INVENTION

1. Field of the Invention

This invention is related to the field of application performance management and, more particularly, to usage measurement and cost allocation.

2. Description of the Related Art

In the information technology (IT) departments of modern organizations, one of the biggest challenges is meeting the increasingly demanding service levels required by users. With more and more applications directly accessible to customers via automated interfaces such as the world wide web, “normal” business hours for many enterprises are now 24 hours a day, 7 days a week. The need for continuous availability and performance of applications has created complex, tiered IT infrastructures which often include web servers, middleware, networking, database, and storage components. These components may be from different vendors and may reside on different computing platforms. A problem with any of these components can impact the performance of applications throughout the enterprise.

The performance of key applications is a function of how well the infrastructure components work in concert with each other to deliver services. With the growing complexity of heterogeneous IT environments, however, the source of performance problems is often unclear. Consequently, application performance problems can be difficult to detect and correct. Furthermore, tracking application performance manually can be an expensive and labor-intensive task. Therefore, it is usually desirable that application performance management tasks be automated.

Automated tools for application performance management may assist in providing a consistently high level of performance and availability. These automated tools may result in lower costs per transaction while maximizing and leveraging the resources that have already been spent on the application delivery infrastructure. Automated tools for application performance management may give finer control of applications to IT departments. Application performance management tools may enable IT departments to be proactive and fix application performance issues before the issues affect users. Historical performance data collected by these tools can be used for reports, trending analyses, and capacity planning. By correlating this collected information across application tiers, application performance management tools may provide actionable advice to help IT departments solve current and potential problems.

For many organizations, measurement of resource utilization is only a first step. To justify investment in IT and otherwise promote accountability, an organization may desire to measure usage and allocate (or “charge back”) the costs of resources to those within the organization who are responsible for usage of those resources. Prior approaches have generally used “head counts” (e.g., number of software licenses), arbitrary percentages, fixed “taxation” models, and similar allocation models. As different entities within an organization may share access to various system resources, these allocation models may fail to accurately reflect actual usage of particular system resources by particular entities. It is desirable to provide improved systems and methods for measuring, reporting, and analyzing usage patterns as well as enabling usage-based cost allocation of system resource usage.

### SUMMARY OF THE INVENTION

Various embodiments of a system and method described herein may provide system resource usage and usage-based cost. The method may include determining a cost for each of a plurality of system resources in a computer system. A cost allocation method may be determined for each of the system resources. Resource usage by a particular organizational unit may be determined for each of the system resources. The cost of resource usage by the organizational unit may be programmatically determined based on the cost for each of the system resources, the cost allocation method for each of the system resources, and the resource usage by the organizational unit for each of the system resources.

### BRIEF DESCRIPTION OF THE DRAWINGS

FIG. 1 illustrates an exemplary performance management system in which embodiments of a system and method for performance management may be implemented.

FIG. 2 illustrates components of an exemplary computer system with which embodiments of a system and method for performance management may be implemented.

FIG. 3 illustrates components of a performance management system including a business efficiency manager (BEM) according to one embodiment.

FIG. 4 illustrates components of a BEM server according to one embodiment.

FIG. 5 is a flowchart which illustrates a method of cost allocation in a performance management system according to one embodiment.

FIG. 6 is a screenshot which shows an example of an application usage view in a resource workspace according to one embodiment.

FIG. 7 is a screenshot which shows an example of a usage over time view in a resource workspace according to one embodiment.

FIG. 8 is a screenshot which shows an example of a usage of features view in a resource workspace according to one embodiment.

FIG. 9 is a screenshot which shows an example of a new users view in a resource workspace according to one embodiment.

FIG. 10 is a screenshot which shows an example of a usage summary view in an organizational unit workspace according to one embodiment.

FIG. 11 is a screenshot which shows an example of an application usage view in an organizational unit workspace according to one embodiment.

FIG. 12 is a screenshot which shows an example of a usage of features view in an organizational unit workspace according to one embodiment.

FIG. 13 is a screenshot which shows an example of a summary view in a cost workspace according to one embodiment.

FIG. 14 is a screenshot which shows an example of an application cost view in a cost workspace according to one embodiment.

FIG. 15 is a screenshot which shows an example of an organizational unit cost view in a cost workspace according to one embodiment.

FIG. 16 is a screenshot which shows an example of an OU cost analysis view in a cost workspace according to one embodiment.

FIG. 17 is a screenshot which shows an example of a summary view in a licenses workspace according to one embodiment.

FIG. 18 is a screenshot which shows an example of a license utilization view in a licenses workspace according to one embodiment.

FIG. 19 is a screenshot which shows an example of an unlicensed usage view in a licenses workspace according to one embodiment.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. As used throughout this application, the word “may” is used in a permissive sense (i.e., meaning “having the potential to”), rather than the mandatory sense (i.e., meaning “must”). Similarly, the words “include,” “including,” and “includes” mean “including, but not limited to.”

### DETAILED DESCRIPTION OF EMBODIMENTS

Various embodiments of a business efficiency manager (BEM) may provide usage-based charge-back using usage data from a performance management system. In other words, the BEM may provide for the allocation of costs for usage of particular system resources to particular units within an organization. System resources may include software (e.g., applications), hardware (e.g., CPU, memory), storage, network resources, or substantially anything whose consumption by one or more users is measurable. Organizational units may include individual users, groups of users, departments, divisions, subdivisions, geographical locales, or any other suitable groups of users within an organization.

A performance management system may include one or more software programs for application performance management and resource usage measurement. By continuously monitoring key components and/or applications of computer systems, the performance management system may collect performance and usage data. Using this data, the performance management system may act to detect and correct performance problems among applications and other system components. The performance management system may provide performance management in a variety of stages, such as: identification of symptoms that could indicate a performance problem, identification of sources or locations of problems, discovery of root causes of problems, recommendation of measures to address the root causes and improve performance, and verification that the measures have achieved desired goals. By defining baselines for “normal” application behavior, the performance management system may automatically detect degradation based on those established norms.

In one embodiment, the performance management system may be implemented in a variety of versions, each of which is customized for management of a particular class of target software: e.g., various products from PeopleSoft, Inc.; Oracle® database management software and related applications; web-based applications; SAP®; various products from Siebel Systems, Inc.; ClarifyCRM™; J2EE™; and other suitable targets. Furthermore, each of the versions may be implemented on one or more computing platforms (e.g., Solaris running on Sun Microsystems™ hardware, or a Microsoft Windows® OS running on Intel-based hardware). As used herein, the term “performance management system” is intended to include all of these disparate, customized software programs.

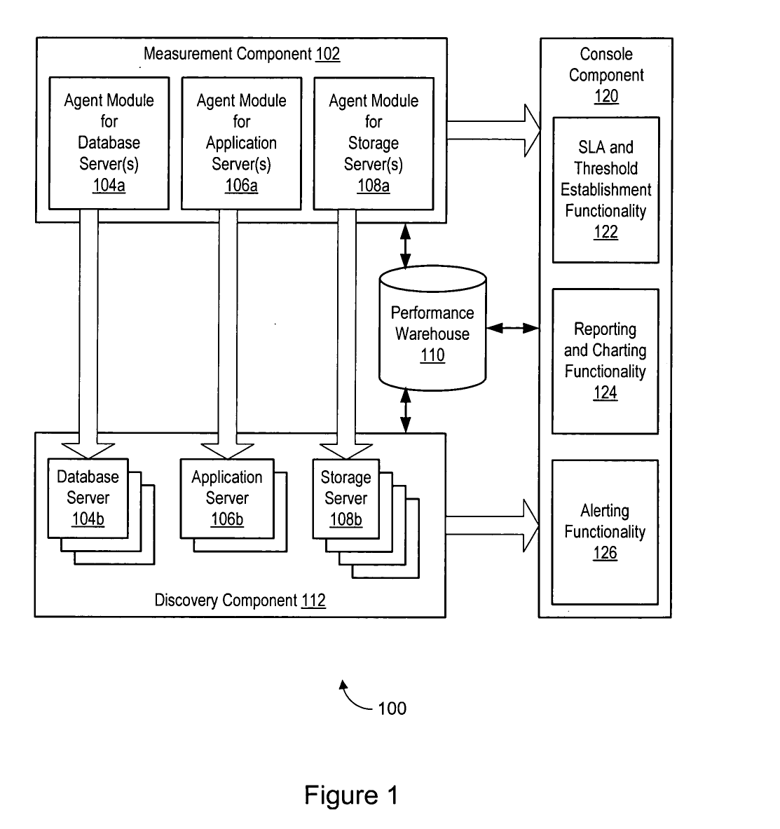

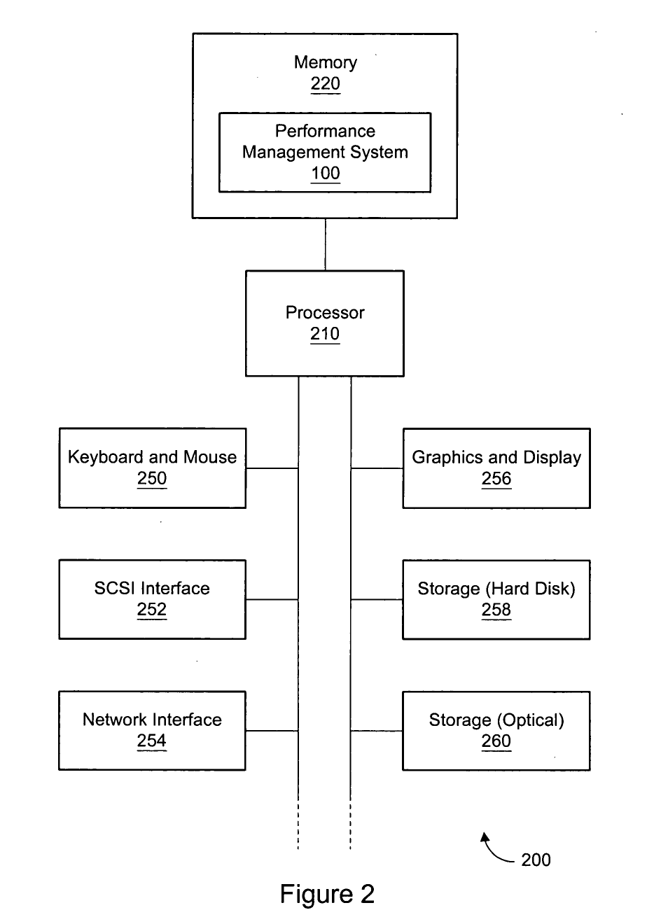

FIG. 1 is an architecture diagram of a performance management system 100 in an exemplary configuration. As illustrated in FIG. 1, the performance management system 100 may include components such as a measurement component 102 (including various agent modules 104a, 106a, and 108a), a discovery component 112, a console component 120, and a performance warehouse 110. The various components of the performance management system 100 may reside on the same computer system, on different computer systems, or on an arbitrary combination of computer systems. An exemplary computer system is illustrated in FIG. 2.

In one embodiment, the measurement component 102 uses agent software to capture performance metrics on servers running target applications. The measurement component 102 may provide a “breadth-wise” view of performance across multiple technology tiers (e.g., web clients, web servers, networks, application servers, database servers, storage servers, etc.). The measurement component 102 may measure, for example, end-to-end response times from the viewpoint of a user. The measurement component 102 may measure segmented response times from tier to tier and may therefore indicate the location of performance problems in a particular tier.

The performance management system 100 may convert the performance data gathered by the measurement component 102 into usage data. The usage data reflects actual usage of monitored applications and system resources by particular users or groups of users. As will be described in greater detail below, the usage data may be used for usage-based charge-back.

In one embodiment, a “base” version of the measurement component 102 may provide monitoring of a limited set of targets (e.g., TCP/IP-based applications). The functionality of the measurement component 102 may be augmented with optional agent modules that are customized to gather and analyze data for particular targets (e.g., web clients, web servers, networks, application servers, database servers, storage servers, etc.). For purposes of illustration and example, three agent modules 104a, 106a, and 108a are shown. Other combinations of agent modules may be used in other configurations.

In one embodiment, the discovery component 112 provides identification and resolution of root causes of performance degradation. By permitting a user to “drill down” through various tiers of hardware and software (e.g., individual servers), the discovery component 112 may provide a “depth-wise” view of performance within each of the tiers that a target application crosses. The discovery component 112 may further indicate steps to be taken to fix current problems or avoid future problems.

In FIG. 1, each of the server blocks 104b, 106b, and 108b within the discovery component 112 are intended to represent installations of agent software on the respective servers. For example, the three database server blocks 104b represent three agent software modules associated with three respective database server installations. Likewise, the two application server blocks 106b represent two agent software modules associated with three respective application server installations, and the four storage server blocks 108b represent four agent software modules associated with four respective storage server installations. The combination of servers 104b, 106b, and 108b is provided for purposes of illustration and example and is not intended to be limiting.

In one embodiment, the console component 120 includes a “watchdog” layer that communicates key performance indicators, such as exceptions to service level agreements (SLAs), to appropriate users at appropriate times. The console component 120 may include functionality 122 for establishing SLAs and other thresholds. The console component 120 may include functionality 124 for reporting and charting. The console component 120 may include functionality 126 for providing alerts. Therefore, the console component 120 may function as a management console for user interaction with the measurement component 102 and discovery component 112.

In one embodiment, the performance warehouse 110 includes a repository of performance metrics which are accessible to the other components in the performance management system 100. The performance metrics may include usage data which reflect usage of applications and system resources by particular consumers. The historical data in the performance warehouse 110 may be used by the other components to provide short- and long-term analysis in varying degrees of detail.

The performance management system 100 of FIG. 1 may be executed by one or more networked computer systems. FIG. 2 is an exemplary block diagram of such a computer system 200. The computer system 200 includes a processor 210 and a memory 220 coupled together by communications bus 205. The processor 210 can be a single processor or a number of individual processors working together. The memory 220 is typically random access memory (RAM), or some other dynamic storage device, and is capable of storing instructions to be executed by the processor 210. For example, the instructions may include instructions for the performance management system 100. The memory 220 may store temporary variables or other intermediate information during the execution of instructions by the processor 210. The memory 220 may store operating system (OS) software to be executed by the processor 210.

In various configurations, the computer system 200 may include devices and components such as a keyboard & mouse 250, a SCSI interface 252, a network interface 254, a graphics & display device 256, a hard disk 258, and/or a CD-ROM 260, all of which are coupled to the processor 210 by a communications bus 207. The network interface 254 may provide a communications link to one or more other computer systems via a LAN (local area network), WAN (wide area network), internet, intranet, or other appropriate networks. It will be apparent to those having ordinary skill in the art that the computer system 200 can also include numerous elements not shown in the figure, such as additional storage devices, communications devices, input devices, and output devices, as illustrated by the ellipsis.

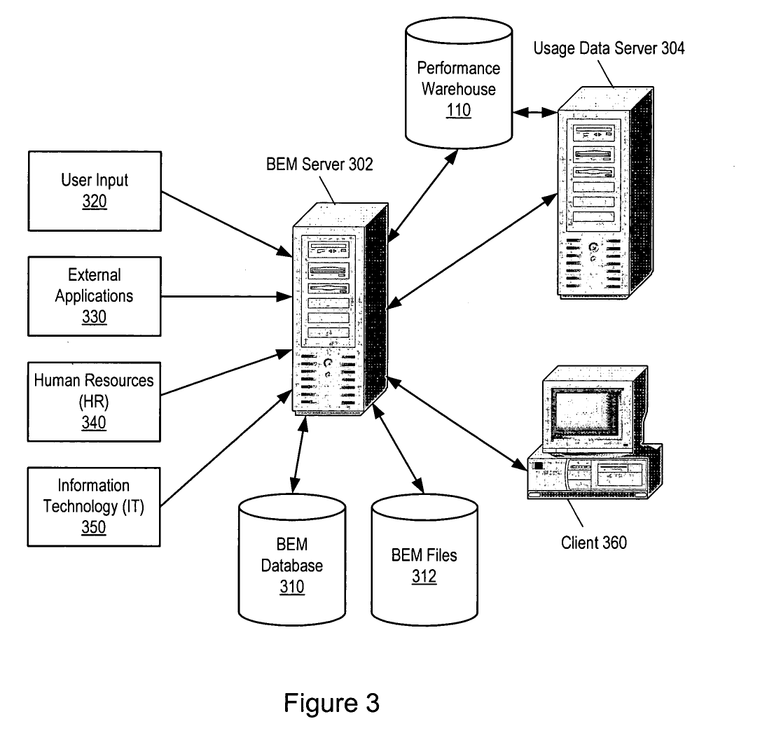

FIG. 3 illustrates components of a performance management system including a business efficiency manager (BEM) according to one embodiment. The BEM may integrate usage data from the performance management system 100 with data such as licensing information, application cost information, and human resources (HR) employees directory to provide an overall view of the resource usage and utilization in the organization. Using the BEM, an organization's IT department and upper management may measure the usage of main business applications, track applications and applications' licenses which are not used, analyze usage patterns, plan for server consolidation and future investments in infrastructure and applications, and provide a platform for the IT organization to charge-back organizational units based on the actual employees' usage of resources.

A BEM server 302 may include an application server and/or a web server for performing usage analysis and/or cost allocation tasks. A BEM database 310 may be used for storage of application and resource usage data, imported data, configuration data, management data, and other data used by the BEM server 302 to perform usage analysis and/or cost allocation tasks. The BEM server 302 may be referred to herein as a “usage analysis and cost allocation server,” and the BEM database 310 may be referred to herein as a “usage analysis and cost allocation database.”

A BEM file repository 312 may be used for temporary storage of data by the BEM server 302. Data in the BEM file repository 312 may be loaded by the BEM server 302 into the BEM database 310. In one embodiment, files in the BEM file repository 312 may be stored as XML files. A BEM console 360 may be used as a client or front-end for the BEM server 302. In one embodiment, the console 360 may execute browser-based software for tasks such as management of cost allocation tasks, usage measurement and analysis, and browsing of usage and cost allocation data. The BEM server 302 and BEM console 360 may be implemented using a computer system such as the exemplary computer system illustrated by FIG. 2.

The performance warehouse 110 and usage data server 304 may provide the BEM server 302 with usage data collected by the performance management system 100. In one embodiment, the BEM database 310 and performance warehouse 110 may be implemented using the same database server. In one embodiment, the BEM server 302 and usage data server 304 may be implemented using the same computer system.

The BEM server 302 may use input from sources other than resource usage data stored in the performance warehouse 110. For example, the BEM server 302 may accept user input 320. The BEM server 302 may accept imported data (e.g., from external applications 330). The BEM server 320 may also accept various forms of employee or human resources (HR) data 340 from the organizational HR system and end-user or information technology (IT) data 350 from the network directory system.

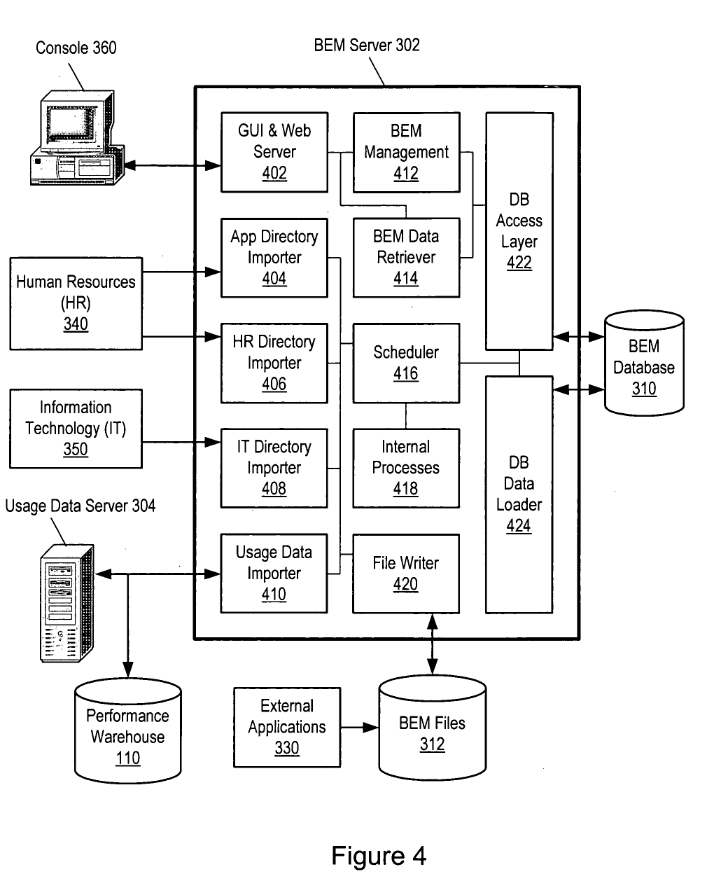

FIG. 4 illustrates components of a BEM server 302 according to one embodiment. A usage data importer 410 may import resource usage data from the performance warehouse 110 and usage data server 304. An application directory importer 404 may import the internal user directories of applications. An HR directory importer 406 may import employee data 340 from HR directories. An IT directory importer 408 may import data (e.g., LDAP-compatible data) 350 from network directories. A database access layer 422 may handle access to the BEM database 310 and may isolate the business logic from the actual database representation. A database data loader 424 may load data to the BEM database 310.

The BEM server 302 may include internal processes 418 such as maintenance operations and self-upgrade. A BEM management component 412 may handle management operations and permissions and may publish a management interface to the GUI component or to management consoles. A BEM data retriever 414 may handle data access and retrieval according to the permission rules. A GUI and web server component 402 may handle a presentation layer for a user interface (e.g., at the client console 360). A file writer 420 may handle write access to the BEM file repository 312. A scheduler 416 may schedule various operations such as data importing and data loading. In one embodiment, tasks may be scheduled to be performed every N hours, every N days or on particular days, at a specific time every N days or on particular days, every N weeks, or at a specific time and date every N weeks.

In one embodiment, configuration of the BEM server 302 may include importing employee data 340 from HR directories. The employee data 340 may be used in defining organizational units for tracking resource usage and allocating resource costs. In defining users within organizational units, the BEM server 302 may match an end-user record from the usage records with an employee record from the HR directory. The ability to match these entities may enable the BEM server 302 to show business views of the usage data and assist in implementing a charge-back policy to the various organizational units based on usage data. In some cases, the matching of the entities may be straightforward, for example, if the application directory already includes a reference to the employee entity or vice-versa. In other cases, such as web application where the only user identifier is an IP address, the BEM administrator may define the matching rules on which the BEM server 302 will perform the match. The matching rules may link pairs of imported directories and fields within those directories.

Configuration of the BEM server 302 may also include defining the system resources to be tracked. In one embodiment, a BEM administrator may select to employ usage-based charge-back for particular resources from a list of resources which are monitored by the performance management system 100. In one embodiment, in defining the system resources to be tracked for usage-based charge-back, the BEM administrator may group multiple instances or modules of a particular application into a single resource or keep the instances or modules as separate resources. In one embodiment, the BEM administrator may create a hierarchy of elements for a particular system resource.

In one embodiment, configuration of the BEM server 302 may also include entering application licensing information. The licensing information may be entered manually or imported automatically. The licensing information may include different types of licenses (e.g., different licenses for different applications), the number of licenses for each type, and license allocations per employee or per organizational unit.

The BEM server 302 may provide flexible, configurable usage-based charge-back wherein particular organizational units are charged for their consumption of particular system resources. The BEM administrator may enter cost elements such as hardware costs, software licenses, IT overhead costs, client installation costs, training costs, and other suitable costs. In some cases, cost elements may be shared among multiple system resources. For each cost element, the BEM administrator may define an allocation method (i.e., how the cost will be allocated), an allocation context (i.e., to whom the cost will be allocated), and a cost.

In one embodiment, allocation methods may include per license, per headcount, per usage time, per active days, per number of activities, and per processing time. Using the per license allocation method, the cost is allocated among the employees who have a client license associated within the selected allocated context. The same percentage may be assigned to each license, regardless of the license type. Using the per headcount allocation method, the cost is allocated by the number of employees in the selected allocation context. Using the per usage time allocation method, the cost is allocated by the percentage of the usage time of each employee from the total usage time of the employees in the selected allocation context. Using the per active days allocation method, the cost is allocated to each employee (in the selected allocation context employee group) by the number of days in which he/she worked with the application as a percentage of the total number of days worked by employees in the selected allocation context. Using the per number of activities allocation method, the cost is allocated by the number of activities performed by the employee as a percentage of the total number of activities performed by employees in the selected allocation context group. Using the per processing time allocation method, the cost is allocated by the processing time consumed by the employee as a percentage of the total processing time consumed by employees in the selected allocation context.

In one embodiment, shared cost elements may use the allocation methods of per license, per headcount, per usage time, per active days, per number of activities, and per processing time. Non-shared cost elements may use the allocation methods of per license and per headcount. License cost elements may use the allocation method of per license. In one embodiment, cost models may have a minimum effective time frame (e.g., one month). In one embodiment, each system resource may use only one cost model in a given time frame.

In one embodiment, the resource cost allocations may be calculated on a regular basis (e.g., monthly). These regular cost allocations may be stored in the BEM database 310. Resource cost allocations may also be calculated “on the fly.”

The following resource cost example is presented for purposes of illustration and is not intended to be limiting. The example is intended to show a cost allocation for a particular system resource for a “sales” organizational unit with a time frame of one year. In this example, the particular system resource (e.g., an application) may be defined to include: shared cost elements of an application server A01 (cost: $8,000, allocation method: per usage time), a database (cost: $6,500, allocation method: per usage time), a server software license (cost: $10,000, allocation method: per headcount), support (cost: $5,000, allocation method: per headcount), and IT management (cost: $6,000, allocation method: per headcount); non-shared cost elements of installation (cost: $10, allocation method: per license) and training (cost: $10, allocation method: per license); and a license costs of a full client license (cost: $100, allocation method: per license) and a self-service license (cost: $15, allocation method: per license).

For the given year, the organization has 1,000 total employees, 200 employees in “sales,” 160 employees in “sales” who required installation and training, 10 full client licenses for “sales,” 150 self-service licenses for “sales,” 2,000 hours of total resource usage time for the entire organization, and 500 hours of total resource usage time for “sales.” Based on this data and the selected cost allocation model, the “sales” organizational unit will be charged a cost of $14,275 for usage of the particular system resource in the given year: $2,000 for the application server A01 (500/200*$8,500), $1,625 for the database (500/2000*$6,500), $2,000 for the server software license (200/1000*$10,000), $1,000 for support (200/1000*$5,000), $1,200 for IT management (200/1000*$6,000), $1,600 for installation (160*$10), $1,600 for training (160*$10), and $3,250 for license costs of the full client license (10*$100) and the self-service license (150*$15).

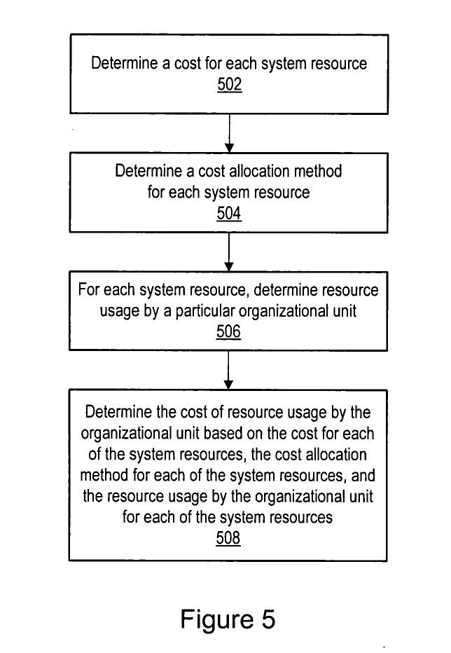

FIG. 5 is a flowchart which illustrates a method of cost allocation in a computer system comprising a plurality of system resources according to one embodiment. In 502 a cost is determined for each of the system resources, as discussed in detail above. In 504 a cost allocation method is determined for each of the system resources, as discussed in detail above. Each system resource may include one or more cost elements, and each cost element may be assigned a cost (e.g., over a particular time frame) and a cost allocation method. Steps 502 and 504 may be performed in either order.

Resource usage by a particular organizational unit is determined for each of the system resources in 506. The resource usage may be determined by using a performance management system to collect performance metrics for one or more of the system resources. The performance metrics may be converted to usage data to reflect actual usage of applications and system resources by consumers. In 508 the cost of resource usage by the organizational unit is determined based on the cost for each of the system resources, the cost allocation method for each of the system resources, and the resource usage by the organizational unit for each of the system resources. The cost of resource usage by the organization unit may be determined automatically and/or programmatically, i.e., by program instructions executed by a computer system.

As illustrated in FIG. 4, the BEM server 402 may include a GUI and web server component 402 for generating a graphical user interface (GUI). By interacting with various workspaces provided by the GUI, the BEM administrator may perform usage analysis. In one embodiment, the BEM GUI may include a resource workspace, an organizational unit workspace, a cost workspace, a licenses workspace, and other suitable workspaces and GUI elements.

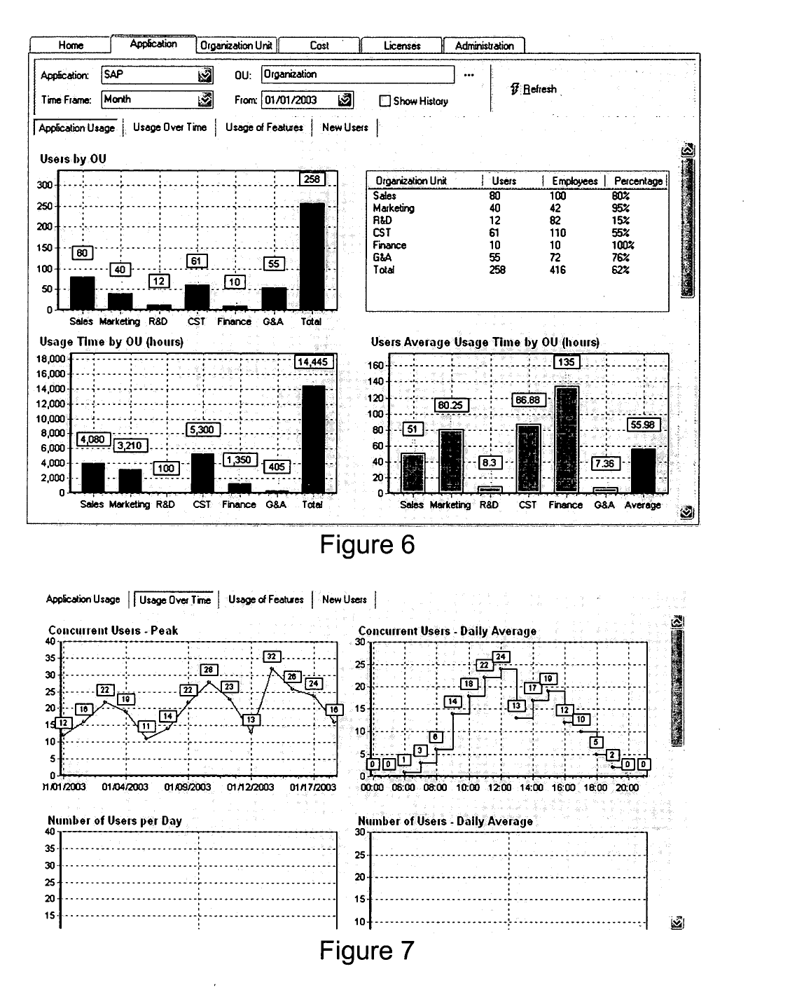

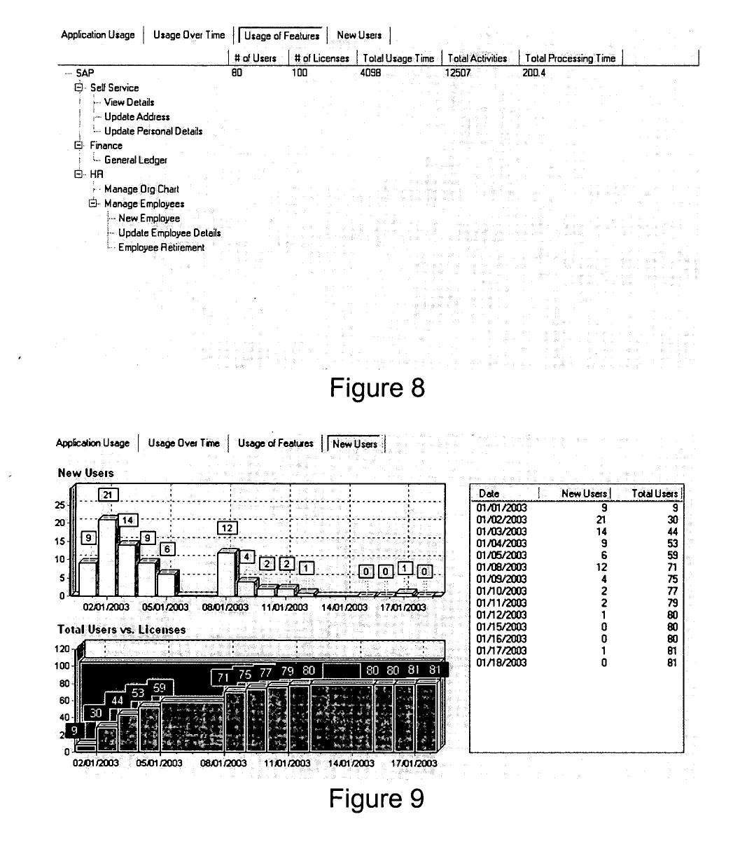

In one embodiment, the GUI may include a resource workspace which permits the BEM administrator to browse usage and cost allocation data for a particular system resource over a user-specified time frame. In one embodiment, the resource workspace may include an application (or resource) usage view, a usage over time view, a usage of features view, and a new users view. FIG. 6 is a screenshot which shows an example of the application usage view according to one embodiment. The application usage view may show summarized information such as who is using the resource, usage time by organizational unit, average usage time per user in an organizational unit, total number of activities organizational unit, average number of activities per user in an organizational unit, total processing time by an organizational unit, and average processing time per user per organizational unit. FIG. 7 is a screenshot which shows an example of the usage over time view according to one embodiment. The usage over time view may show daily and daily average values of the usage parameters across the selected time period (e.g., concurrent usage, usage time, number of activities and process time total). FIG. 8 is a screenshot which shows an example of the usage of features view according to one embodiment. The usage of features view may show how the various features of the application are used. The usage of features view may display a tree view of the application (or resource) modules and features, and for each feature, the following data: number of users (that used the feature), number of licenses available (only when applicable), total usage time and total processing time. FIG. 9 is a screenshot which shows an example of the new users view according to one embodiment. The new users view may show new user entrances to the system by organizational unit, by total users of the system, and by the number of licenses for the new users.

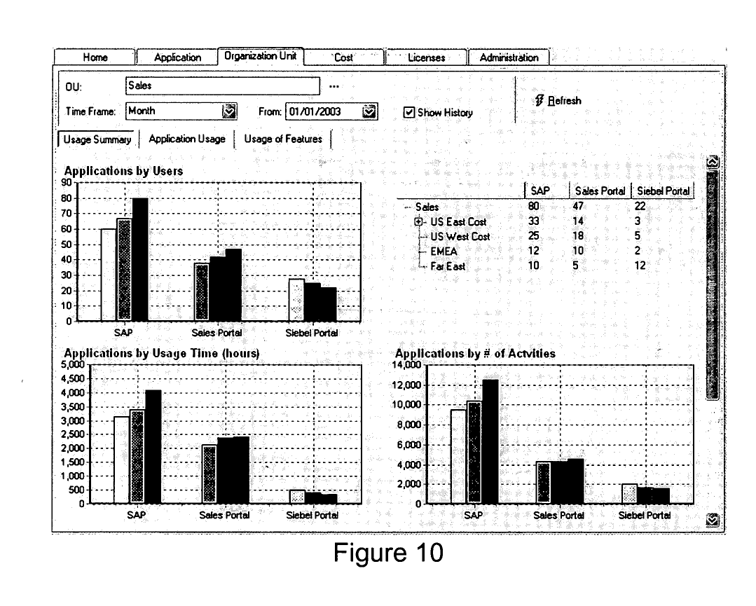

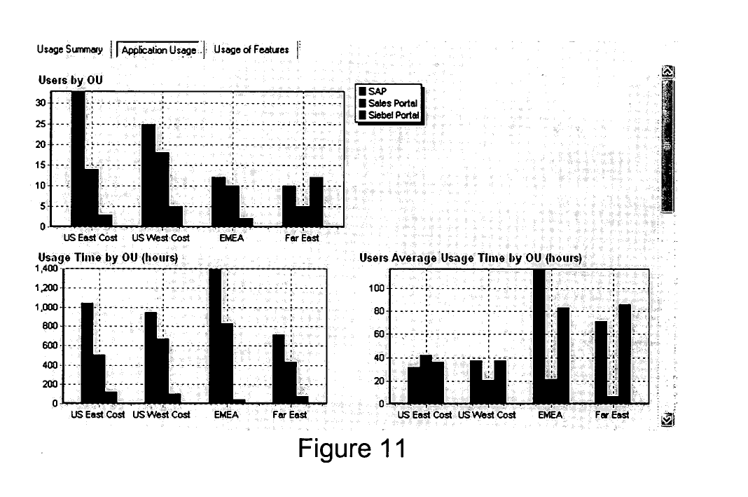

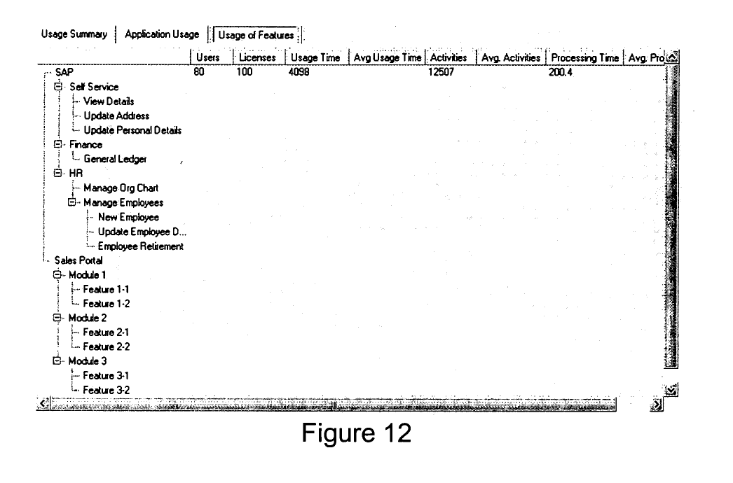

In one embodiment, the GUI may include an organizational unit workspace which permits the BEM administrator to browse usage and cost allocation data for a particular organizational unit over a user-specified time frame. In one embodiment, the resource workspace may include a usage summary view, an application (or resource) usage view, and a usage of features view. FIG. 10 is a screenshot which shows an example of the usage summary view according to one embodiment. The usage summary view may show a high level summary of the resources used by the organization unit's employees: e.g., which Applications, how many users uses each application, how much time is spent on each Application and how many Activities. FIG. 11 is a screenshot which shows an example of the application usage view according to one embodiment. The application usage view may show statistical data about the applications (or other resources) used by the employees of the organization unit (OU): e.g., which resources they used, usage time (in hours) by OU, employee average usage time, number of activities per OU, average user activities, processing time by OU, average users' processing time, daily visits, and average daily visits. FIG. 12 is a screenshot which shows an example of the usage of features view according to one embodiment. The usage of features view may show how the various features of all resources are used by the OU. The usage of features view may display a tree view of the resource modules and features, and for each feature, the following data: number of users (that used the feature), number of licenses available (only when applicable), total usage time, and total processing time.

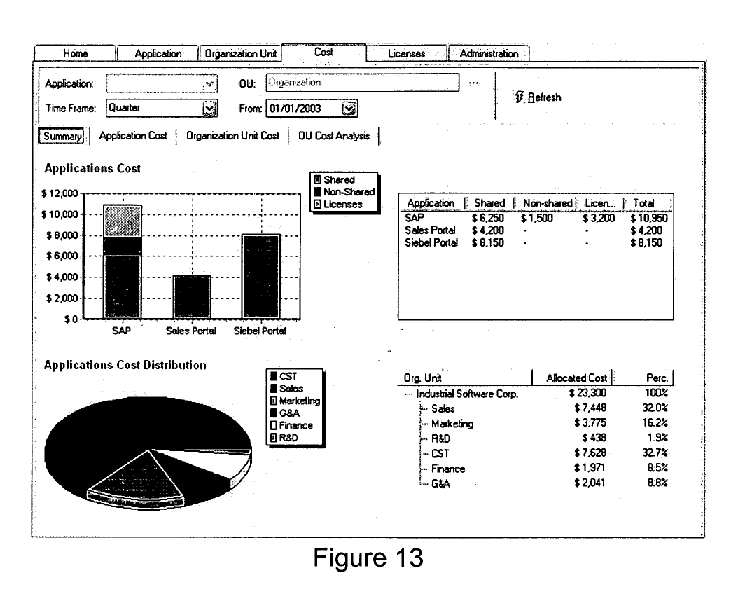

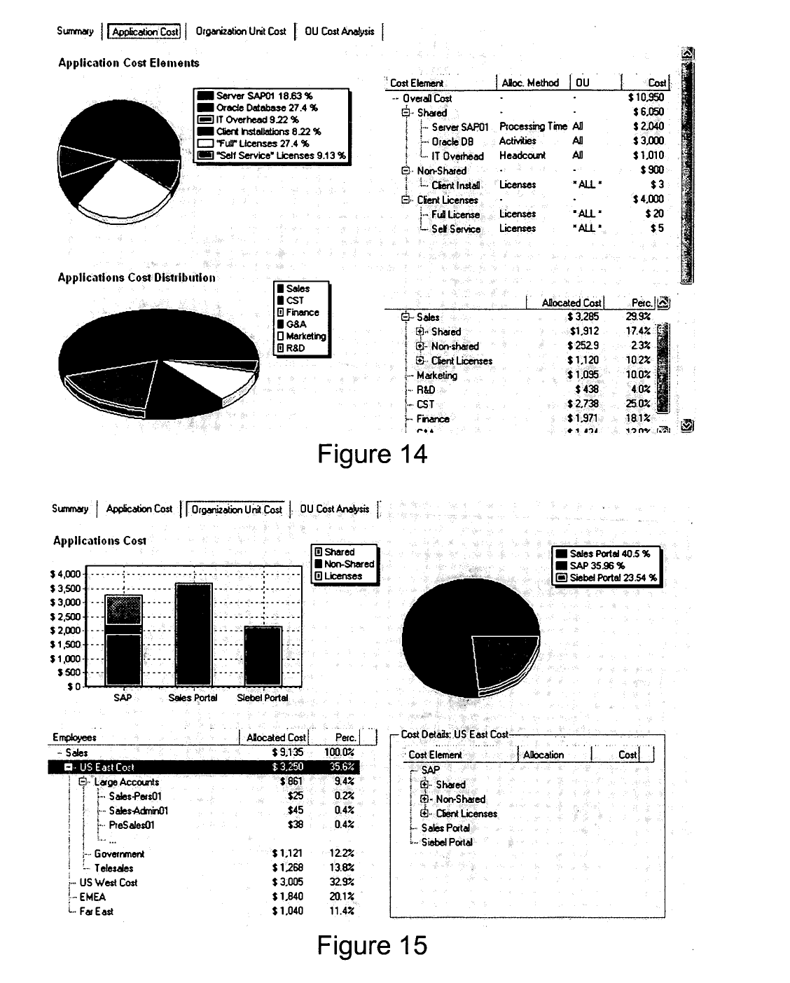

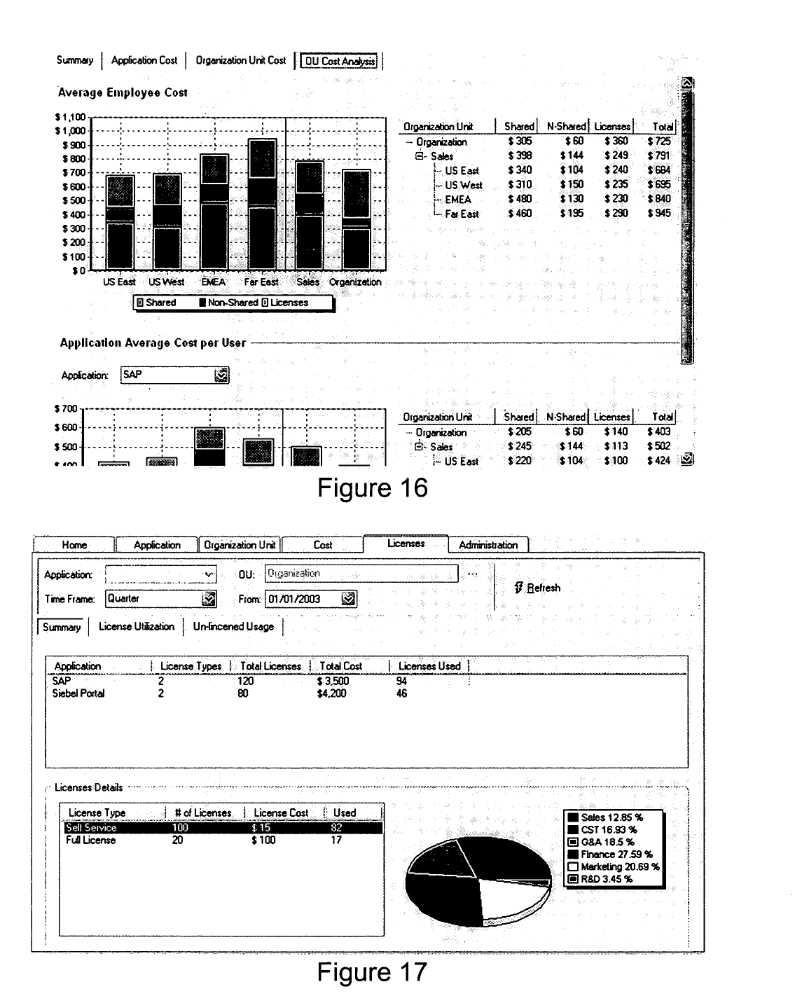

In one embodiment, the GUI may include a cost workspace which permits the BEM administrator to browse cost data over a user-specified time frame. In one embodiment, the cost workspace may include a summary view, an application (or resource) cost view, an organizational unit cost view, and an OU cost analysis view. FIG. 13 is a screenshot which shows an example of the summary view according to one embodiment. The summary view may show a global view on the cost data: e.g., what resources are tracked, how much they cost, and how this cost is distributed to the top-level organizational units. FIG. 14 is a screenshot which shows an example of the application cost view according to one embodiment. The application cost view may show cost information for one application (or resource): e.g., how the application cost is calculated (cost elements, allocation method, allocation target, and element cost) and how this cost is distributed to the top-level organizational units. FIG. 15 is a screenshot which shows an example of the organizational unit cost view according to one embodiment. The organizational unit cost view may show cost information for an organizational unit: e.g., how much the OU is charged for each resource and the distribution of this cost in the selected organization down to the employee level. FIG. 16 is a screenshot which shows an example of the OU cost analysis view according to one embodiment. The OU cost analysis view may show additional insight to the information shown in the organizational unit cost view: e.g., (total) average employee cost for each sub-OU under the selected organization unit as well as application specific average cost per employee.

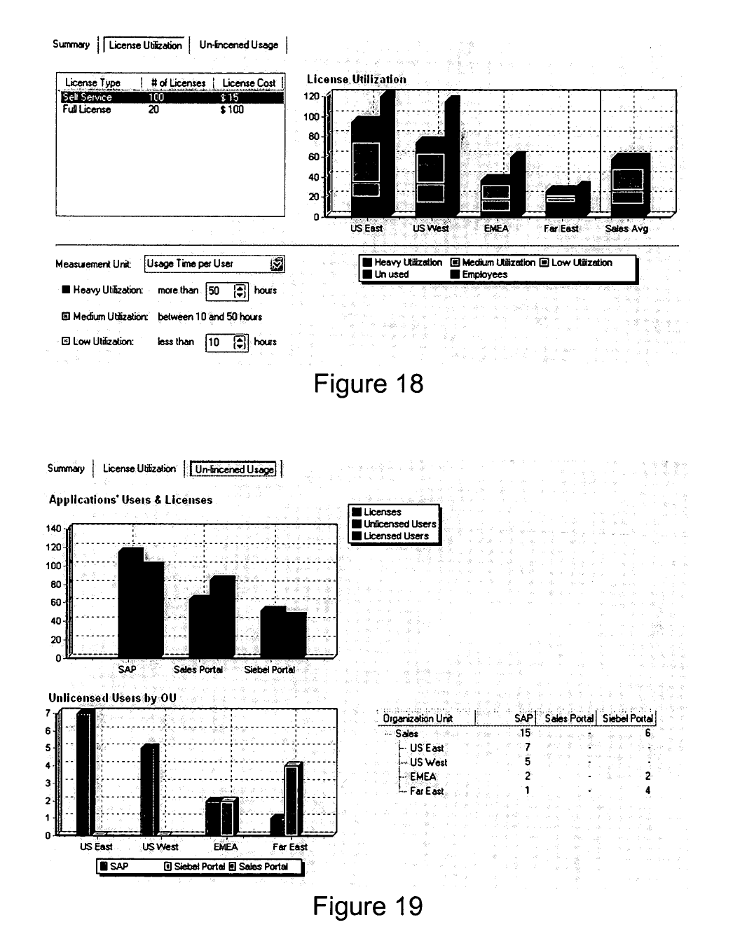

In one embodiment, the GUI may include a licenses workspace which permits the BEM administrator to browse license data over a user-specified time frame. In one embodiment, the license workspace may include a summary view, a license utilization view, and an unlicensed usage view. FIG. 17 is a screenshot which shows an example of the summary view according to one embodiment. The summary view may show a global view of the licensing data: e.g., which licenses were entered to the BEM server 302, which license types, and high level allocation to organization units. FIG. 18 is a screenshot which shows an example of the license utilization view according to one embodiment. The license utilization view may show the license utilization of a selected application in an OU. The license utilization view may allow the BEM administrator to define the metric that will be used to analyze the license utilization (e.g., selected from: Usage Time per User, Number of Activities per User, Total Processing time per User and Daily Visits per User) and the values for heavy, medium, and low usage. FIG. 19 is a screenshot which shows an example of the unlicensed usage view according to one embodiment. The unlicensed usage view may show whether there are more users than licenses entered to the system. The unlicensed usage view may show an overview licensing picture and, for each sub-OU for the selected organizational unit, how many un-licensed users for each resource.

It is further noted that any of the embodiments described above may further include receiving, sending or storing instructions and/or data that implement the operations described above in conjunction with FIGS. 1-19 upon a computer readable medium. Generally speaking, a computer readable medium may include storage media or memory media such as magnetic or optical media, e.g. disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals conveyed via a communication medium such as network and/or a wireless link.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for allocating resource usage costs in a computer system comprising a plurality of system resources, the method comprising:
determining a cost for each of the plurality of system resources;
determining a cost allocation method for each of the plurality of system resources from a plurality of available cost allocation methods;
determining resource usage by an organizational unit for each of the plurality of system resources; and
programmatically determining a cost of resource usage by the organizational unit based on the cost for each of the plurality of system resources, the cost allocation method for each of the plurality of system resources, and the resource usage by the organizational unit for each of the plurality of system resources.

2. The method of claim 1,
wherein each of the plurality of system resources comprises one or more cost elements, and wherein a cost allocation method is determined for each of the one or more cost elements.

3. The method of claim 1,
wherein the plurality of available cost allocation methods comprises a per license cost allocation method.

4. The method of claim 1,
wherein the plurality of available cost allocation methods comprises a per headcount cost allocation method.

5. The method of claim 1,
wherein the plurality of available cost allocation methods comprises a per usage time cost allocation method.

6. The method of claim 1,
wherein the plurality of available cost allocation methods comprises a per active days cost allocation method.

7. The method of claim 1,
wherein the plurality of available cost allocation methods comprises a per number of activities cost allocation method.

8. The method of claim 1,
wherein the plurality of available cost allocation methods comprises a per processing time cost allocation method.

9. The method of claim 1,
wherein the determining resource usage by an organizational unit for each of the plurality of system resources comprises using a performance management system to collect usage data for one or more of the plurality of system resources.

10. The method of claim 1, further comprising:
defining the organizational unit by using employee data imported from a human resources directory.

11. A carrier medium comprising program instructions for allocating resource usage costs in a computer system comprising a plurality of system resources, wherein the program instructions are computer-executable to implement:
determining a cost for each of the plurality of system resources;
determining a cost allocation method for each of the plurality of system resources from a plurality of available cost allocation methods;
determining resource usage by an organizational unit for each of the plurality of system resources; and
programmatically determining a cost of resource usage by the organizational unit based on the cost for each of the plurality of system resources, the cost allocation method for each of the plurality of system resources, and the resource usage by the organizational unit for each of the plurality of system resources.

12. The carrier medium of claim 11,
wherein each of the plurality of system resources comprises one or more cost elements, and wherein a cost allocation method is determined for each of the one or more cost elements.

13. The carrier medium of claim 11,
wherein the plurality of available cost allocation methods comprises a per usage time cost allocation method.

14. The carrier medium of claim 11,
wherein the plurality of available cost allocation methods comprises a per processing time cost allocation method.

15. The carrier medium of claim 11,
wherein the determining resource usage by an organizational unit for each of the plurality of system resources comprises using a performance management system to collect usage data for one or more of the plurality of system resources.

16. The carrier medium of claim 11, wherein the program instructions are further computer-executable to implement:
defining the organizational unit by using employee data imported from a human resources directory.

17. A system for allocating resource usage costs for usage of a plurality of system resources, the system comprising:
a usage analysis and cost allocation server;
a usage analysis and cost allocation database which is coupled to the usage analysis and cost allocation server;
wherein the usage analysis and cost allocation server is operable to:
determine a cost for each of the plurality of system resources;
store the cost for each of the plurality of system resources in the usage analysis and cost allocation database;
determine a cost allocation method for each of the plurality of system resources from a plurality of available cost allocation methods;
store the cost allocation method for each of the plurality of system resources in the usage analysis and cost allocation database;
determine resource usage by an organizational unit for each of the plurality of system resources; and
determine a cost of resource usage by the organizational unit based on the cost for each of the plurality of system resources, the cost allocation method for each of the plurality of system resources, and the resource usage by the organizational unit for each of the plurality of system resources.

18. The system of claim 17,
wherein each of the plurality of system resources comprises one or more cost elements, and wherein a cost allocation method is determined for each of the one or more cost elements.

19. The system of claim 17,
wherein the plurality of available cost allocation methods comprises a per usage time cost allocation method.

20. The system of claim 17,
wherein the plurality of available cost allocation methods comprises a per processing time cost allocation method.

21. The system of claim 17,
wherein in determining the resource usage by an organizational unit for each of the plurality of system resources, the usage analysis and cost allocation server is operable to use a performance management system to collect usage data for one or more of the plurality of system resources.

22. The system of claim 17, wherein usage analysis and cost allocation server is further operable to:
define the organizational unit by using employee data imported from a human resources directory.

23. A system for allocating resource usage costs in a computer system comprising a plurality of system resources, the system comprising:
means for determining a cost for each of the plurality of system resources;
means for determining a cost allocation method for each of the plurality of system resources from a plurality of available cost allocation methods;
means for determining resource usage by an organizational unit for each of the plurality of system resources; and
means for programmatically determining a cost of resource usage by the organizational unit based on the cost for each of the plurality of system resources, the cost allocation method for each of the plurality of system resources, and the resource usage by the organizational unit for each of the plurality of system resources.
